(19) United States
(12) Patent Application Publication
(10) Pub. No.: US 2019/0236592 A1
(43) Pub. Date: Aug. 1, 2019

(54) COMPUTER SYSTEM AND COMPUTER-IMPLEMENTED METHOD FOR SECURE E-COMMERCE

(71) Applicant: Mastercard International Incorporated, Purchase, NY (US)

(72) Inventor: Ankur Arora, New Delhi (IN)

(73) Assignee: Mastercard International Incorporated, Purchase, NY (US)

(21) Appl. No.: 16/256,853

(22) Filed: Jan. 24, 2019

(30) Foreign Application Priority Data
Jan. 26, 2018 (SG) 10201800711V

(51) Int. Cl. G06Q 20/36; G06Q 20/40

(52) U.S. Cl. CPC G06Q 20/3674; G06Q 20/4014; G06Q 20/3672

(57) ABSTRACT

A payment network server for secure e-commerce is described. The payment network server comprises at least a computer processor and a data storage device, the data storage device comprising instructions operative by the computer processor to: receive, from an issuer server associated with an issuer application, a request for a payment token, the request comprising a payment amount and a transaction time from an e-commerce site of a merchant and a customer identifier verified by the issuer application; generate a payment token comprising the payment amount, the transaction time and a tokenized personal account number (PAN) associated with the customer identifier, the payment token being generated in an encrypted form; transmit the payment token to the issuer application for uploading into the e-commerce site; receive, from the e-commerce site, a payment transaction request comprising the payment token and the merchant identifier; decrypt the payment token back into the payment amount, the transaction time and the tokenized personal account number (PAN); map the tokenized personal account number (PAN) to a customer personal account number (PAN); and transmit the payment amount, the transaction time, the customer personal account number (PAN) and the merchant identifier to the issuer server for validation and authorisation of the payment transaction request.

### CROSS REFERENCE TO RELATED APPLICATIONS

This application claims priority to Singaporean Application Serial No. 10201800711V, filed Jan. 26, 2018, which is incorporated herein by reference in its entirety

### FIELD OF THE INVENTION

The present invention relates to a computer system and computer-implemented method for secure e-commerce.

### BACKGROUND OF THE INVENTION

E-commerce is becoming more and more prevalent as both merchants and customers are increasingly taking advantage of internet-enabled platforms for shopping, paying bills and transferring money. However, in all of these scenarios customers are required to enter sensitive payment card data (i.e. a card number, expiry date and card verification value (CVV)) into a website to initiate a payment transaction. This process makes the payment card data susceptible to fraud.

To overcome the above, some online merchants use other payment mechanisms such as PayPal™, Amazon Pay™ or cash on delivery. However, these systems either require a customer to pre-register with the payment service provider or require the merchant to bear the cost of a product until cash is provided on delivery.

It is therefore an aim of the present invention to provide an improved computer system and computer-implemented method for secure e-commerce.

### SUMMARY OF THE INVENTION

In general terms, the present disclosure proposes a computer system and computer-implemented method for secure e-commerce whereby a customer is not required to provide any payment card details to an e-commerce site of a merchant. Instead, an encrypted payment token is generated by a payment network server and this is provided to the e-commerce site to initiate a payment transaction request.

In a first aspect of the present invention, there is provided a payment network server for secure e-commerce. The payment network server comprises at least a computer processor and a data storage device, the data storage device comprising instructions operative by the computer processor to:
receive, from an issuer server associated with an issuer application, a request for a payment token, the request comprising a payment amount and a transaction time from an e-commerce site of a merchant and a customer identifier verified by the issuer application;
generate a payment token comprising the payment amount, the transaction time and a tokenized personal account number (PAN) associated with the customer identifier, the payment token being generated in an encrypted form;
transmit the payment token to the issuer application for uploading into the e-commerce site;
receive, from the e-commerce site, a payment transaction request comprising the payment token and the merchant identifier;
decrypt the payment token back into the payment amount, the transaction time and the tokenized personal account number (PAN);
map the tokenized personal account number (PAN) to a customer personal account number (PAN); and
transmit the payment amount, the transaction time, the customer personal account number (PAN) and the merchant identifier to the issuer server for validation and authorisation of the payment transaction request.

Thus, embodiments of the invention comprise a payment network server configured for secure e-commerce (i.e. to secure an electronic payment gateway) wherein only encrypted payment card details are provided to the e-commerce site so as to not compromise the security of the payment card used for the payment transaction. Accordingly, a customer's payment card details are kept secure and the likelihood of card fraud is greatly reduced.

Notably, the payment token comprises the payment amount, the transaction time and the tokenized personal account number (PAN) associated with the customer identifier. This allows the issuer server to validate the payment amount and transaction time received from the payment network server against a payment amount and transaction time received from the issuer application to initiate the request for the payment token. If the payment amounts and transaction times both match, the issuer server may authorise the payment transaction request. Furthermore, the inclusion of multiple data fields within the payment token further reduces the risk of fraud since more details are verified before the payment transaction is authorised.

The payment token may further comprise the merchant identifier from the e-commerce site of the merchant, which is received as part of the request for the payment token.

The e-commerce site may be in the form of a website or an application (App).

The payment network server may query a customer database to obtain the tokenized personal account number (PAN) associated with the customer identifier and/or to map the tokenized personal account number (PAN) to the customer personal account number (PAN).

The payment token may be transmitted directly to the issuer application or may be sent via the issuer server.

In a second aspect of the present invention, there is described a computerised network for secure e-commerce. The network comprises:
a payment network server according to the first aspect of the invention; and
an issuer server comprising at least an issuer computer processor and an issuer data storage device, the issuer data storage device comprising instructions operative by the issuer computer processor to:
receive, from the issuer application, the request for the payment token;
store, in a payment token database, the payment amount and the transaction time comprised in the request;
transmit to the payment network server the request for the payment token;
receive, from the payment network server, the payment token;
transmit the payment token to the issuer application for uploading into the e-commerce site;
receive, from the payment network server, the payment amount, the transaction time, the customer personal account number (PAN) and the merchant identifier;
validate the payment amount and the transaction time received from the payment network server by comparison with the payment amount and the transaction time stored in the payment token database; and
authorise the payment transaction request if the payment amount and the transaction time received from the payment network server match the payment amount and the transaction time stored in the payment token database.

In a third aspect of the present invention, there is described a computer-implemented method for secure e-commerce. The method comprises a computer processor of a payment network server:
receiving, from an issuer server associated with an issuer application, a request for a payment token, the request comprising a payment amount and a transaction time from an e-commerce site of a merchant and a customer identifier verified by the issuer application;
generating a payment token comprising the payment amount, the transaction time and a tokenized personal account number (PAN) associated with the customer identifier, the payment token being generated in an encrypted form;
transmitting the payment token to the issuer application for uploading into the e-commerce site;
receiving, from the e-commerce site, a payment transaction request comprising the payment token and the merchant identifier;
decrypting the payment token back into the payment amount, the transaction time and the tokenized personal account number (PAN);
mapping the tokenized personal account number (PAN) to a customer personal account number (PAN); and
transmitting the payment amount, the transaction time, the customer personal account number (PAN) and the merchant identifier to the issuer server for validation and authorisation of the payment transaction request.

In a fourth aspect of the present invention, there is provided a non-transitory computer-readable medium having stored thereon program instructions for causing at least one processor to perform the method according to the third aspect of the invention.

Thus, the computer system and computer-implemented method provide convenience with improved security for payment transactions because a customer is not required to provide any payment card details to an e-commerce site of a merchant. Instead, an encrypted payment token is generated by the payment network server and this is provided to the e-commerce site to initiate the payment transaction request.

Other desirable features and characteristics will become apparent from the subsequent detailed description and the appended claims, taken in conjunction with the accompanying drawings of the disclosure. Moreover, within the scope of this proposed disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Non-limiting embodiments of the invention will now be described for the sake of example only, with reference to the following drawings in which:

FIG. 1 shows a computerised network for secure e-commerce in accordance with an embodiment of the invention;

FIG. 2 shows the steps of a method for secure e-commerce in accordance with an embodiment of the invention, which may be performed by a payment network server comprised in the computerised network of FIG. 1;

FIG. 3 shows schematically the functional structure of the payment network server comprised in the computerised network of FIG. 1, in accordance with an embodiment of the invention;

FIG. 4 shows schematically the physical structure of the payment network server (and other servers) comprised in the computerised network of FIG. 1; and

FIG. 5 shows schematically the physical structure of a customer electronic device comprised in the computerised network of FIG. 1.

### DETAILED DESCRIPTION OF THE EMBODIMENT

As used herein, the term “account” refers to any form of arrangement that a customer has with an institution that allows the customer to deposit and/or withdraw funds. An account can be a deposit account, a credit card account, a debit card account, a current account, a saving account, an overdraft account, an electronic wallet account or any other type of account offered by the institution. Furthermore, the account may be a loan account in which case the customer owes money to the institution. In some embodiments, an account may be associated with a payment card, such as a credit card, a debit card, a prepaid card, a charge card, a membership card, a promotional card, a frequent flyer card, an identification card, a prepaid card, a gift card, and/or any other device that may hold account information, such as mobile phones, smartphones, personal digital assistants (PDAs), key fobs, transponder devices, NFC-enabled devices, and/or computers.

The term “institution” is not necessarily limited to organizations which are legally constituted as banks, since in some jurisdictions other organizations may be permitted to maintain accounts. For example, an institution associated with an acquirer or an issuer can be one of the following: a bank, a financial technology company, or a financial institution.

The terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

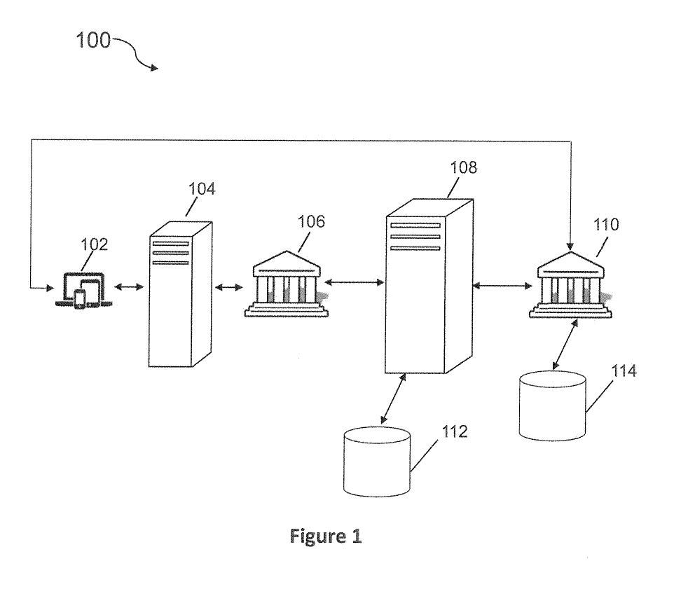

Referring to FIG. 1, an example of a computerised network 100 for secure e-commerce, in accordance with an embodiment of the invention, is shown. The computerised network 100 comprises a customer electronic device 102 allowing a customer to access an e-commerce site of a merchant, a merchant server 104 associated with the e-commerce site, an acquirer server 106 associated with an acquirer institution for the merchant, a payment network server 108 and an issuer server 110 associated with an issuer institution for the customer. The payment network server 108 is operationally connected to a customer database 112 and the issuer server 110 is operationally connected to a payment token database 114.

The customer electronic device 102 may take the form of a mobile phone, tablet, laptop, computer or other internet-enabled device. The e-commerce site may be in the form of a website or an application (App).

In a particular embodiment, when the customer wishes to make a payment transaction for goods or services purchased from the merchant via the e-commerce site, the customer will be prompted to enter a mode of payment into the e-commerce site during a ‘checkout’ procedure. The mode of payment may be selected from a list comprising bank payment, card payment, wallet payment etc. The customer will also be prompted to enter the name of the issuer institution (i.e. the bank or card issuer associated with the chosen mode of payment) into the e-commerce site. The e-commerce site will then redirect the customer to a website or application associated with the issuer institution (i.e. an issuer application). The e-commerce site may use a link (e.g. similar to a “mail to” email link) to open the issuer application, which may be pre-installed on the customer electronic device 102. The e-commerce site may also transmit purchase data relating to the payment transaction the customer wishes to make. The purchase data may comprise one or more of a merchant identifier, a payment amount and a transaction time (e.g. a timestamp generated by the e-commerce site during the ‘checkout’ procedure initiated by the customer). The merchant identifier may comprise one or more of a merchant name, IP address and merchant account details. The issuer application will authenticate the customer in the same way it would for making any payment transaction request. For example, the customer may be prompted to enter a personal identification number (PIN) or biometric into the issuer application to verify the customer's identity and the issuer application may check that the entered PIN or biometric matches that stored in a database (either locally, on the customer electronic device 102, or remotely, e.g. on the issuer server 110). Once the customer is authenticated, the issuer application may prompt the customer to select a payment card (issued by the issuer institution) for use in the payment transaction. The issuer application may also prompt the customer to confirm that the payment transaction is to proceed (e.g. by confirming that the merchant identifier and/or the payment amount are correct). Once confirmed, the issuer application will transmit a request for a payment token to the issuer server 110. The request comprises the payment amount, the transaction time and a customer identifier which identifies the customer authenticated by the issuer application. The customer identifier may also identify the payment card selected by the customer for use in the payment transaction.

The issuer server 110 received the request for the payment token sent by the issuer application and stores, in the payment token database 114, the payment amount and the transaction time comprised in the request. The issuer server 110 then transmits to the payment network server 108 the request for the payment token.

The payment network server 108 receives the request for the payment token from the issuer server 110 and generates a payment token (in an encrypted from) comprising the payment amount, the transaction time and a tokenized personal account number (PAN) associated with the customer identifier. The payment network server may query the customer database 112 to obtain the tokenized personal account number (PAN) associated with the customer identifier. The payment token may further comprise the merchant identifier from the e-commerce site of the merchant, received as part of the request for the payment token. In which case, the payment token may be configured for use specifically at the e-commerce site of the merchant. The payment token may have a pre-determined expiry time (of, e.g. 1, 2, 3, 4, 5 or 10 minutes) such that the payment network server 108 will not process the payment token for a payment transaction if it is received at the payment network server 108 after the pre-determined expiry time has expired. The payment network server 108 transmits the payment token to the issuer application for uploading into the e-commerce site as a mode of payment.

In some embodiments, the payment token may be transmitted directly to the issuer application while, in other embodiments, the payment token may be transmitted to the issuer application via the issuer server 110. In the latter case, the issuer server 110 receives, from the payment network server 108, the payment token, and transmits the payment token to the issuer application for uploading into the e-commerce site.

The issuer application receives the payment token and it is subsequently uploaded into the e-commerce site (or payment gateway). The customer may copy and paste the payment token from the issuer application directly into the e-commerce site or payment gateway. In some embodiments, the customer may download the payment token from the issuer application and upload it into the e-commerce site or payment gateway. The customer may then confirm via the e-commerce site that the payment transaction is to proceed using the payment token and the e-commerce site will transmit the payment token in a payment transaction request using existing processes for a card payment. In particular, the payment transaction request will be routed via the merchant server 104 to the acquirer server 106 and then on to the payment network server 108.

The payment network server 108 will therefore receive, from the e-commerce site (via the merchant server 104 and acquirer server 106), a payment transaction request comprising the payment token and the merchant identifier. The payment network server 108 will decrypt the payment token back into the payment amount, the transaction time and the tokenized personal account number (PAN). The payment network server 108 will map the tokenized personal account number (PAN) to a customer personal account number (PAN), for example, by querying the customer database 112. The payment network server 108 may check the pre-determined expiry time to ensure that the payment token is still valid before processing the payment token as described below. The payment network server 108 may also check an expiry date associated with the customer personal account number (PAN) before proceeding with the payment transaction. The expiry date may be comprised in the payment token or retrieved from the customer database 112 along with the customer personal account number (PAN). The payment network server 108 will transmit the payment amount, the transaction time, the customer personal account number (PAN) and the merchant identifier to the issuer server 110 for validation and authorisation of the payment transaction request.

The issuer server 110 will therefore receive, from the payment network server 108, the payment amount, the transaction time, the customer personal account number (PAN) and the merchant identifier. The issuer server 110 will validate the payment amount and the transaction time received from the payment network server 108 by comparison with the payment amount and the transaction time stored in the payment token database 114. If the payment amount and the transaction time received from the payment network server match the payment amount and the transaction time stored in the payment token database, the issuer server will authorise the payment transaction request. In some embodiments, the issuer server 110 may also check if a customer account associated with the customer personal account number (PAN) has sufficient funds before proceeding to authorise the payment transaction request. Upon successful authorisation, the issuer server 110 may send an authorisation response to the e-commerce site (e.g. using an internet protocol (IP) address for the e-commerce site). The authorisation response may comprise one or more of the payment amount, the transaction time, the customer identifier, the tokenized personal account number (PAN) and the merchant identifier.

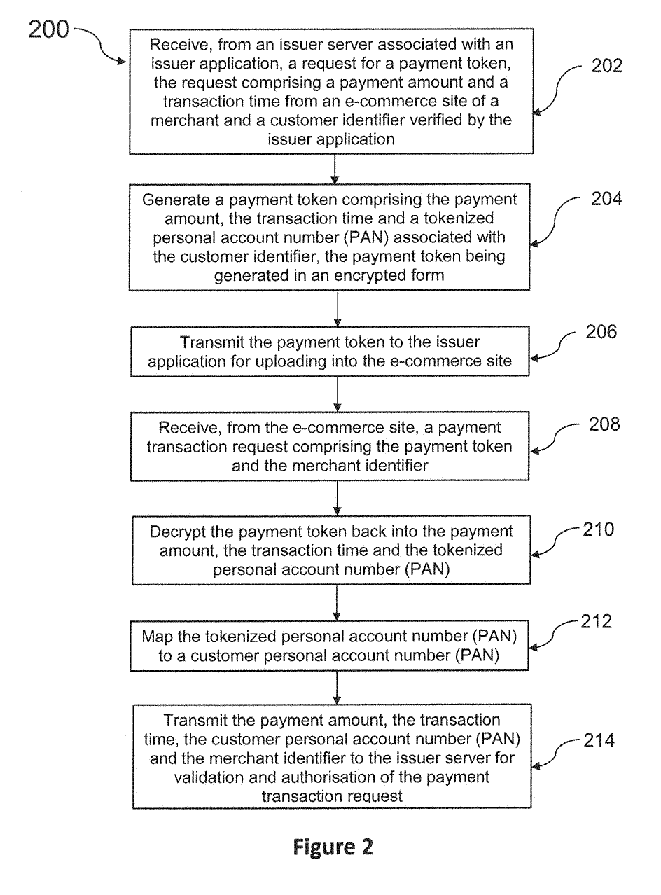

FIG. 2 shows the steps of a method 200 for secure e-commerce in accordance with an embodiment of the invention, which may be performed by the payment network server 108 of the computerised network 100 of FIG. 1. Thus, the payment network server 108 is configured to perform the following steps:
a) in a step 202, receive, from an issuer server associated with an issuer application, a request for a payment token, the request comprising a payment amount and a transaction time from an e-commerce site of a merchant and a customer identifier verified by the issuer application;
b) in a step 204, generate a payment token comprising the payment amount, the transaction time and a tokenized personal account number (PAN) associated with the customer identifier, the payment token being generated in an encrypted form;
c) in a step 206, transmit the payment token to the issuer application for uploading into the e-commerce site;
d) in a step 208, receive, from the e-commerce site, a payment transaction request comprising the payment token and the merchant identifier;
e) in a step 210, decrypt the payment token back into the payment amount, the transaction time and the tokenized personal account number (PAN);
f) in a step 212, map the tokenized personal account number (PAN) to a customer personal account number (PAN); and
g) in a step 214, transmit the payment amount, the transaction time, the customer personal account number (PAN) and the merchant identifier to the issuer server for validation and authorisation of the payment transaction request.

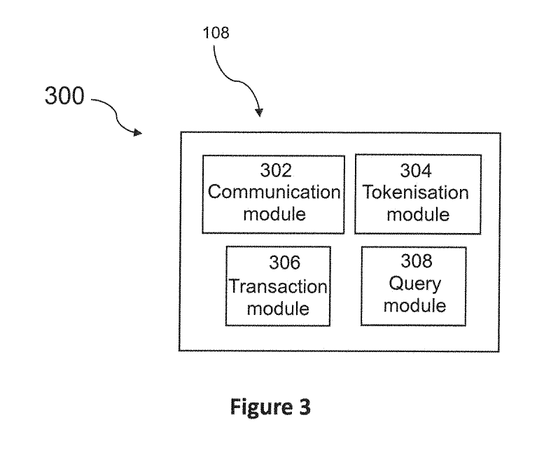

FIG. 3 shows schematically the structure 300 of the payment network server 108 of the computerised network 100 of FIG. 1 which carries out the method 200 of FIG. 2 in accordance with embodiments of the invention. The structure 300 of the payment network server 108 comprises a communication module 302, a tokenisation module 304, a transaction module 306 and a query module 308. Each of these modules is described in more detail below.

The communication module 302 is configured to communicate with the issuer server 110, the acquirer server 106 and the customer database 112 in order to carry out the method of FIG. 2. For example, the communication module 302 receives, from the issuer server 110 associated with the issuer application, the request for the payment token, the request comprising the payment amount and the transaction time from the e-commerce site of the merchant and the customer identifier verified by the issuer application. The communication module 302 passes the request for the payment token to the tokenization module 304 and, in return, receives the payment token and transmits the payment token to the issuer application for uploading into the e-commerce site. The communication module subsequently, receives, from the e-commerce site, a payment transaction request comprising the payment token and the merchant identifier and passes the payment transaction request to the transaction module 306. The communication module then receives the payment amount, the transaction time, the customer personal account number (PAN) and the merchant identifier and transmits this information to the issuer server 110 for validation and authorisation of the payment transaction request.

The tokenisation module 304 is configured to receive from the communication module 302 the request for the payment token and generates in an encrypted form, a payment token comprising the payment amount, the transaction time and a tokenized personal account number (PAN) associated with the customer identifier.

The transaction module 306 is configured to receive from the communication module 302 the payment transaction request and to decrypt the payment token, comprised in the payment transaction request, back into the payment amount, the transaction time and the tokenized personal account number (PAN). The transaction module 306 instructs the query module 308 to derive the customer personal account number (PAN) from the tokenized personal account number (PAN).

The query module 308 is configured to map the tokenized personal account number (PAN) to the customer personal account number (PAN) upon instruction from the transaction module 306. In so doing, the query module 308 will query the customer database 112 to obtain the customer personal account number (PAN) associated with the tokenized personal account number (PAN). The customer personal account number (PAN) is then passed to the communication module 302 for transmission to the issuer server 110, along with the payment amount, the transaction time and the merchant identifier, for validation and authorisation of the payment transaction request.

Embodiments of the invention therefore provide a system and method for secure e-commerce transactions in which a customer's card details are not required to be entered into an e-commerce site of a merchant. Instead, through tokenisation and the method described above a secure payment transaction can be made via an e-commerce site thus reducing the risk of fraud and providing greater confidence to e-commerce customers.

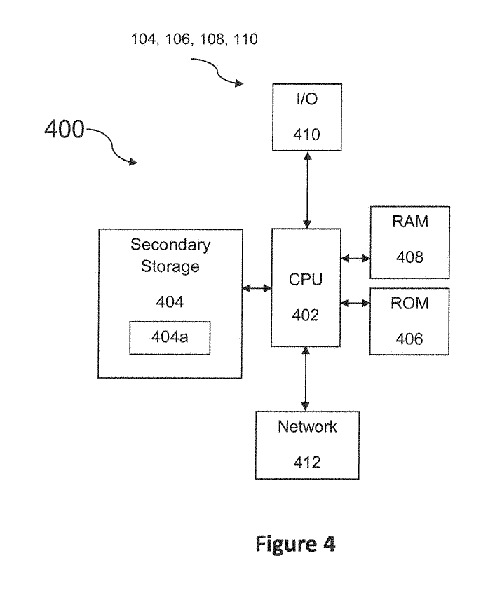

FIG. 4 is a block diagram showing a technical architecture 400 of the merchant server 104, the acquirer server 106, the payment network server 108 and/or the issuer server 110.

The technical architecture 400 includes a processor 402 (which may be referred to as a central processor unit or CPU) that is in communication with memory devices including secondary storage 404 (such as disk drives), read only memory (ROM) 406, and random access memory (RAM) 408. The processor 402 may be implemented as one or more CPU chips. The technical architecture may further comprise input/output (I/O) devices 410, and network connectivity devices 412.

The secondary storage 404 is typically comprised of one or more disk drives or tape drives and is used for non-volatile storage of data and as an over-flow data storage device if RAM 408 is not large enough to hold all working data. Secondary storage 404 may be used to store programs which are loaded into RAM 408 when such programs are selected for execution.

In this embodiment, the secondary storage 404 has a processing component 404a comprising non-transitory instructions operative by the processor 402 to perform various operations of the method of the present disclosure. The ROM 406 is used to store instructions and perhaps data which are read during program execution. The secondary storage 404, the RAM 408, and/or the ROM 406 may be referred to in some contexts as computer readable storage media and/or non-transitory computer readable media.

I/O devices 410 may include printers, video monitors, liquid crystal displays (LCDs), plasma displays, touch screen displays, keyboards, keypads, switches, dials, mice, track balls, voice recognizers, card readers, paper tape readers, or other input devices.

The network connectivity devices 412 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 412 may enable the processor 402 to communicate with the Internet or one or more intranets. With such a network connection, it is contemplated that the processor 402 might receive information from the network, or might output information to the network in the course of performing the above-described method operations. Such information, which is often represented as a sequence of instructions to be executed using processor 402, may be received from and outputted to the network, for example, in the form of a computer data signal embodied in a carrier wave.

The processor 402 executes instructions, codes, computer programs, scripts which it accesses from hard disk, floppy disk, optical disk (these various disk based systems may all be considered secondary storage 404), flash drive, ROM 406, RAM 408, or the network connectivity devices 412. While only one processor 402 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 400 to provide the functionality of a number of servers that is not directly bound to the number of computers in the technical architecture 400. In an embodiment, the functionality disclosed above may be provided by executing an application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 402, the RAM 408, and the ROM 406 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

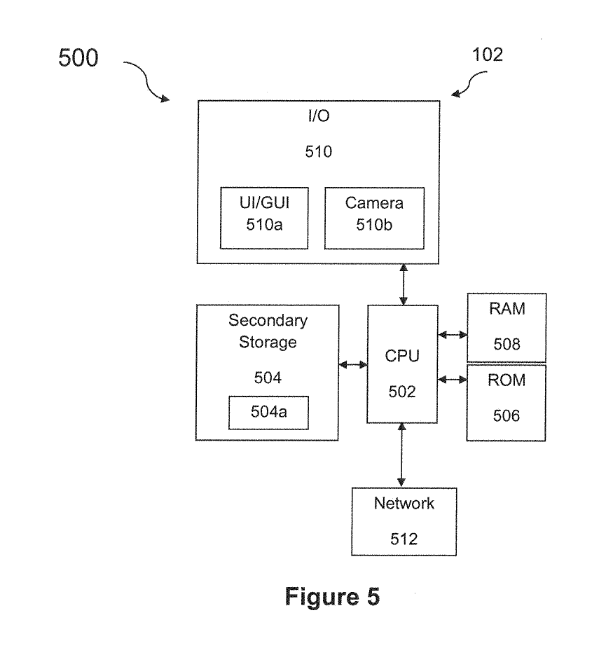

FIG. 5 is a block diagram showing a technical architecture 500 of a communication device (e.g. the customer electronic device 102 of FIG. 1). The technical architecture includes a processor 502 (which may be referred to as a central processor unit or CPU) that is in communication with memory devices including secondary storage 504 (such as disk drives or memory cards), read only memory (ROM) 506, and random access memory (RAM) 508. The processor 502 may be implemented as one or more CPU chips. The technical architecture further comprises input/output (I/O) devices 510, and network connectivity devices 512.

The I/O devices 510 comprise a customer interface (UI) 510a and a camera 510b. The UI 510a may comprise a screen in the form of a touch screen, a keyboard, a keypad or other known input device. The camera 510b is a device for recording visual images in the form of photographs, film or video signals. The UI 510a may be configured to operate with the processor 502 together with the memory devices 504, 506, 508 in conjunction with the network connectivity devices 512 to display to the customer an authentication request requesting for a customer authentication identifier to be input via the I/O devices 510. The customer authentication identifier may be input via the UI 510a or the camera 510b (e.g. if the customer authentication identifier is associated with a biometric identifier).

The secondary storage 504 is typically comprised of a memory card or other storage device and is used for non-volatile storage of data and as an over-flow data storage device if RAM 508 is not large enough to hold all working data. Secondary storage 504 may be used to store programs which are loaded into RAM 508 when such programs are selected for execution.

In this embodiment, the secondary storage 504 has a processing component 504a, comprising non-transitory instructions operative by the processor 502 to perform various operations of the method of the present disclosure. The ROM 506 is used to store instructions and perhaps data which are read during program execution. The secondary storage 504, the RAM 508, and/or the ROM 506 may be referred to in some contexts as computer readable storage media and/or non-transitory computer readable media.

The network connectivity devices 512 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 512 may enable the processor 502 to communicate with the Internet or one or more intranets. With such a network connection, it is contemplated that the processor 502 might receive information from the network, or might output information to the network in the course of performing the above-described method operations. Such information, which is often represented as a sequence of instructions to be executed using processor 502, may be received from and outputted to the network, for example, in the form of a computer data signal embodied in a carrier wave. In embodiments, the network connectivity devices 512 enable the customer electronic device 102 to be communicatively connected to other parts of the computerized network of FIG. 1. The network connectivity devices 512 may also enable the customer electronic device 102 to be in communication with the merchant server 104 and/or the payment network server 108 and/or the issuer server 110.

The processor 502 executes instructions, codes, computer programs, scripts which it accesses from hard disk, floppy disk, optical disk (these various disk based systems may all be considered secondary storage 504), flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. In an embodiment, if an App compatible with the authentication process is used, the processor 502 is configured to execute the App stored in the ROM 506 and/or RAM 508 or the secondary storage 504 for authentication of a payment transaction or an ATM transaction as described in the exemplary embodiments.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A payment network server for secure e-commerce, the payment network server comprising at least a computer processor and a data storage device, the data storage device comprising instructions operative by the computer processor to:
receive, from an issuer server associated with an issuer application, a request for a payment token, the request comprising a payment amount and a transaction time from an e-commerce site of a merchant and a customer identifier verified by the issuer application;
generate a payment token comprising the payment amount, the transaction time and a tokenized personal account number (PAN) associated with the customer identifier, the payment token being generated in an encrypted form;
transmit the payment token to the issuer application for uploading into the e-commerce site;
receive, from the e-commerce site, a payment transaction request comprising the payment token and the merchant identifier;
decrypt the payment token back into the payment amount, the transaction time and the tokenized personal account number (PAN);
map the tokenized personal account number (PAN) to a customer personal account number (PAN); and
transmit the payment amount, the transaction time, the customer personal account number (PAN) and the merchant identifier to the issuer server for validation and authorisation of the payment transaction request.

2. The payment network server according to claim 1 wherein the payment token further comprises the merchant identifier from the e-commerce site of the merchant, which is received as part of the request for the payment token.

3. The payment network server according to claim 1 wherein the e-commerce site is in the form of a website.

4. The payment network server according to claim 1 wherein the e-commerce site is in the form of an application (App).

5. The payment network server according to claim 1 further configured to query a customer database to obtain the tokenized personal account number (PAN) associated with the customer identifier and/or to map the tokenized personal account number (PAN) to the customer personal account number (PAN).

6. The payment network server according to claim 1 configured to transmit the payment token directly to the issuer application.

7. The payment network server according to claim 1 configured to transmit the payment token to the issuer application via the issuer server.

8. The payment network server according to claim 2 wherein the e-commerce site is in the form of a website.

9. The payment network server according to claim 2 wherein the e-commerce site is in the form of an application (App).

10. The payment network server according to claim 2 further configured to query a customer database to obtain the tokenized personal account number (PAN) associated with the customer identifier and/or to map the tokenized personal account number (PAN) to the customer personal account number (PAN).

11. The payment network server according to claim 3 further configured to query a customer database to obtain the tokenized personal account number (PAN) associated with the customer identifier and/or to map the tokenized personal account number (PAN) to the customer personal account number (PAN).

12. The payment network server according to claim 4 further configured to query a customer database to obtain the tokenized personal account number (PAN) associated with the customer identifier and/or to map the tokenized personal account number (PAN) to the customer personal account number (PAN).

13. The payment network server according to claim 8 further configured to query a customer database to obtain the tokenized personal account number (PAN) associated with the customer identifier and/or to map the tokenized personal account number (PAN) to the customer personal account number (PAN).

14. The payment network server according to claim 9 further configured to query a customer database to obtain the tokenized personal account number (PAN) associated with the customer identifier and/or to map the tokenized personal account number (PAN) to the customer personal account number (PAN).

15. The payment network server according to claim 2 configured to transmit the payment token directly to the issuer application.

16. The payment network server according to claim 3 configured to transmit the payment token directly to the issuer application.

17. The payment network server according to claim 4 configured to transmit the payment token directly to the issuer application.

18. A computerised network for secure e-commerce comprising:
a) a payment network server according to any preceding claim; and
b) an issuer server comprising at least an issuer computer processor and an issuer data storage device, the issuer data storage device comprising instructions operative by the issuer computer processor to:
receive, from the issuer application, the request for the payment token;
store, in a payment token database, the payment amount and the transaction time comprised in the request;
transmit to the payment network server the request for the payment token;
receive, from the payment network server, the payment token;
transmit the payment token to the issuer application for uploading into the e-commerce site;
receive, from the payment network server, the payment amount, the transaction time, the customer personal account number (PAN) and the merchant identifier;
validate the payment amount and the transaction time received from the payment network server by comparison with the payment amount and the transaction time stored in the payment token database; and
authorise the payment transaction request if the payment amount and the transaction time received from the payment network server match the payment amount and the transaction time stored in the payment token database.

19. A computer-implemented method for secure e-commerce comprising:
receiving, from an issuer server associated with an issuer application, a request for a payment token, the request comprising a payment amount and a transaction time from an e-commerce site of a merchant and a customer identifier verified by the issuer application;
generating a payment token comprising the payment amount, the transaction time and a tokenized personal account number (PAN) associated with the customer identifier, the payment token being generated in an encrypted form;
transmitting the payment token to the issuer application for uploading into the e-commerce site;
receiving, from the e-commerce site, a payment transaction request comprising the payment token and the merchant identifier;
decrypting the payment token back into the payment amount, the transaction time and the tokenized personal account number (PAN);
mapping the tokenized personal account number (PAN) to a customer personal account number (PAN); and
transmitting the payment amount, the transaction time, the customer personal account number (PAN) and the merchant identifier to the issuer server for validation and authorisation of the payment transaction request.

20. A non-transitory computer-readable medium having stored thereon program instructions for causing at least one processor to perform the method according to claim 19.
